(19) United States
(12) Patent Application Publication
(10) Pub. No.: US 2025/0341822 A1
(43) Pub. Date: Nov. 6, 2025

(54) IN SITU DEFECT DETECTION OF ADDITIVELY-MANUFACTURED ARTICLES USING GRAPH NEURAL NETWORKS

(71) Applicant: The Boeing Company, Arlington, VA (US)

(72) Inventors: Robert Grube, Edmonds, WA (US); Eric Clough, Santa Monica, CA (US); Anup Singh, Bangalore (IN); Sushant Kumar Seet, Bangalore (IN); Rajkumar Srinivasan, Bangalore (IN); Brittan Farmer, Madison, AL (US); Jazib Hassan, Munich (DE); Taisia Lou, Olivette, MO (US); Dana Henshaw, Seattle, WA (US); Eric Chapman, Lake Tapps, WA (US); Qin Jiang, Oak Park, CA (US)

(21) Appl. No.: 18/653,819

(22) Filed: May 2, 2024

(51) Int. Cl. G05B 19/418; G05B 13/02

(52) U.S. Cl. CPC G05B 19/41875; G05B 13/0265

(57) ABSTRACT

In situ defect detection of additively-manufactured articles using graph neural networks are provided. One aspect includes a computing device comprising processing circuitry and memory storing instructions that, when executed by the processing circuitry, causes the processing circuitry to store a graph comprising a plurality of light intensity values measured in situ during an additive manufacturing process and to generate an output describing a predicted defect in the graph using a graph neural network, wherein the graph neural network has been trained using labeled training data generated by a process comprising storing a training graph comprising a plurality of training light intensity values measured in situ during a training additive manufacturing process of the training article, determining one or more defect locations of the training article, determining a plurality of training sub-graphs from the training graph, and pairing a training sub-graph with defect information.

### FIELD

The field of invention relates generally to defect detection in additive manufacturing processes, and more specifically, in-situ defect detection in additive manufacturing processes using neural networks.

### BACKGROUND

Additive manufacturing (AM), also known as three-dimensional (3D) printing, refers to technologies for fabricating or “printing” three-dimensional objects by forming and bonding successive layers. Various types of AM processes exist. One common class of AM processes includes the fabrication of polymer objects. In polymer AM processes, polymers can be extruded or jetted onto a printing platform and subsequently cured to form a layer. Depending on the materials used, different curing processes can be applied. Example curing processes include thermal-curing, photo-curing, and the use of adhesives.

Another class of AM processes includes metal printing for the fabrication of objects using various types of metals and alloys. One example includes powder bed fusion processes. In powder bed fusion, a layer of metallic material, typically in the form of metallic powder, is deposited onto a printing platform. Electron beams, lasers, or other thermal sources are used to selectively melt or sinter a desired pattern from the deposited layer of material. The process is repeated to build successive layers to form the final object. Examples of such processes include direct metal laser melting (DMLM), direct metal laser sintering (DMLS), electron beam melting (EBM), selective laser sintering (SLS), and selective heat sintering (SHS).

### SUMMARY

Techniques for in situ defect detection of additively-manufactured articles using graph neural networks are provided. One aspect includes a computing device for detecting defects in an additively-manufactured article, the computing device comprising processing circuitry and memory storing instructions that, when executed by the processing circuitry, causes the processing circuitry to store a graph comprising a plurality of light intensity values measured in situ during an additive manufacturing process of the additively-manufactured article and to generate an output describing a predicted defect in the graph using a graph neural network, wherein the graph neural network has been trained using labeled training data generated by a process comprising storing a training graph comprising a plurality of training light intensity values measured in situ during a training additive manufacturing process of the training article, determining one or more defect locations of the training article, determining a plurality of training sub-graphs from the training graph, and pairing a training sub-graph of the plurality of training sub-graphs with defect information to form a labeled pair to be included in the labeled training data, wherein the defect information describes whether a defect is spatially present in the paired training sub-graph based on the determined one or more defect locations.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a schematic view of an example computing system for performing defect detection of an additively-manufactured part using a trained graph neural network.

FIG. 2 shows a flow chart of an example inference process for a trained graph neural network, which can be implemented using the example computing system of FIG. 1.

FIG. 3 shows a flow chart of an example training process for a graph neural network, which can be implemented using the example computing system of FIG. 1.

FIG. 4 shows a schematic view of an example graph neural network architecture, which can be implemented in the trained graph neural network of FIG. 1.

FIG. 5 shows a model of an example conical sub-graph containing a detected defect.

FIG. 6 shows a schematic view of an example data structure of a graph constructed using in situ melt pool measurements of an additive manufacturing process.

FIG. 7 shows a flow chart of an example method for performing defect detection of an additively-manufactured part, which can be implemented using the example computing system of FIG. 1.

FIG. 8 shows a schematic view of an example computing environment that can enact one or more of the methods and processes described herein.

### DETAILED DESCRIPTION

In metal additive manufacturing processes, various types of faults and deformations, such as but not limited to voids, can form within the fabricated parts. Such defects within a fabricated part may render the part unsuitable for use depending on the application. For example, in certain aerospace applications, fabricated metal parts with too many voids or voids that are too large can be unsuitable for use as such defects can compromise the mechanical and structural integrity of the parts. Current solutions for detecting manufacturing defects in additively-manufactured parts generally involve time-consuming and/or expensive methods. For example, computed tomography (CT) imaging can be used to provide a non-destructive inspection of an additively-manufactured part. However, in high-volume applications, performing CT imaging on every manufactured part for defect detection can be infeasible with respect to time and/or cost. Another method for finding defects in an additively-manufactured part includes taking apart and physically inspecting the part internally. Although such methods can be accurate and reliable, the additively-manufactured part is destroyed. As such, destructive methods are generally used for sampling parts to perform batch quality control, which can be insufficient for many applications.

In view of the observations above, non-destructive methods utilizing graph neural networks and in situ measurements taken during an AM process can be implemented to model and predict defects in an additively-manufactured part resulting from said AM process. The locations and sizes of defects in an additively-manufactured part can correlate to transient process conditions during the AM process. A model can be developed to approximate the likelihood of defects in the interior of an additively-manufactured part from in situ measurements taken during the AM process. For example, in additive manufacturing processes utilizing a laser source for melting and binding material (e.g., metal AM processes), in situ measurements of melt pool characteristics can be used to predict defects using a graph neural network.

A graph neural network is a type of artificial neural network that processes graph data to perform probabilistic predictions. The in situ melt pool measurements can be used to construct graphs in which the graph neural network attempts to classify their nodes as either a solid node (which indicates a likelihood of no defect) or a void node (which indicates a likelihood of a defect). Different likelihood thresholds may be defined. For the training of such graph neural networks, a training dataset can be constructed using labeled data pairs that include in situ melt pool measurements (or the derived graph data) for a given additively-manufactured part and corresponding data describing defects for said part. The data describing the defects can, for example, be derived using other techniques for detecting defects in additively-manufactured parts, such as but not limited to CT imaging.

Defect prediction techniques using graph neural networks and in situ measurements of an AM process provide several technical advantages. In some implementations, the in situ measurements includes spatiotemporal information of melt pools formed during the AM process. Such melt pool data can be monitored layer-by-layer to predict the likelihood of defect formation. As the prediction process can be performed during the AM process, such techniques could be used, for example, to stop a current fabrication process if a large defect is likely to have formed or if too many defects have likely been formed. If the part being fabricated is expected with high confidence to have more defects or larger defects than desired, then the fabrication process can be halted, saving the time and material required to finish the process compared to if in situ defect prediction was not in place. Additionally, this can also save the time and cost of doing post-build inspection.

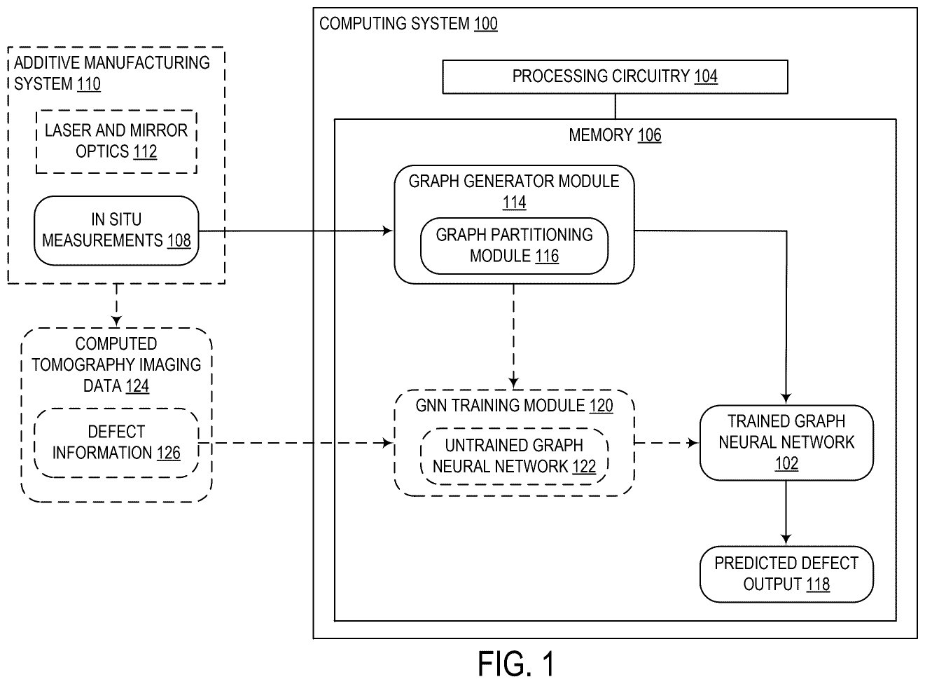

Turning now to the drawings, defect detection techniques for additively-manufactured parts using graph neural networks and in situ measurements are described in further detail. FIG. 1 shows a schematic view of an example computing system 100 for performing defect detection of an additively-manufactured part using a trained graph neural network 102. The example computing system 100 can be implemented with various types of computing devices, including but not limited to personal computers, mobile devices, servers, etc. The example computing system 100 includes at least processing circuitry 104 coupled to memory 106 storing instructions that, during execution by the processing circuitry 104, causes the processing circuitry 104 to at least perform the various processes described herein.

The example computing system 100 can be implemented to perform defect detection of an additively manufactured part using in situ measurements 108 taken during the AM process of said part. The in situ measurements 108 can be received from various sources. In the depicted example of FIG. 1, the in situ measurements 108 are provided by an additive manufacturing system 110 fabricating the part on which the defect detection is performed. Various types of in situ measurements 108 can be utilized along with graph neural networks configured for such measurements. For example, for additively-manufactured parts fabricated using metal AM processes, in situ measurements describing characteristics of melt pools formed during the fabrication process can be utilized. Examples of melt pool characteristics include but not limited to color temperature values and light intensity values (luminance).

In some implementations, an in situ measurement 108 includes temporal and/or spatial information describing the time and/or location at which the measurement was taken during the AM process. Spatial information in the in situ measurements 108 can reflect melt pool spacings for an AM process, which can differ depending on the application. In some implementations, the hatch spacing and layer spacing of the AM process is non-uniform. Conventional approaches for analyzing defects, such as image-based convolutional neural networks, generally analyze input data in a uniform, gridded manner. On the other hand, the use of graphs representing melt pool data, which is typically spatially non-uniform, enables the use of non-gridded data that more accurately reflect the AM process.

The in situ measurements 108 can be measured in various ways, which can depend on the type of measurement and/or AM process implemented. In a metal AM process, in situ measurements of melt pool characteristics can be recorded using sensors that are aligned, or substantially aligned, with the power source that is melting/sintering the metallic materials. Accordingly, the sensors would be in line, or substantially in line, with the melt pools formed during the AM process. In the depicted example of FIG. 1, the additive manufacturing system 110 includes laser and mirror optics 112 for generating and directing power to melt/sinter metallic material. One or more sensors for measuring melt pool characteristics (e.g., light intensity sensors for measuring luminance values) can be co-positioned with the laser optics, utilizing a similar, or substantially similar, optical path as the laser optics to perform measurements on the melt pools.

Once received, the in situ measurements 108 can be converted into graph data using a graph generator module 114. The graph stores information from, or derived from, the in situ measurements 108 within the nodes and/or edges that make up the graph. For example, nodes within the graph can store light intensity values derived from the in situ measurements of corresponding melt pools. The graph can be fed into the trained graph neural network 102 to perform defect prediction. The graph data can be generated in various ways. Depending on the graph neural network implemented, the graph data format can vary. For example, the graph neural network may be trained on graphs of certain sizes. In some implementations, the graph neural network is implemented to detect one or more defects in a fabricated part using a graph representing the entire fabricated part.

In some implementations, the graph neural network is implemented to detect one or more defects within a portion of the fabricated part. In such cases, the graph generated from the in situ measurements can be partitioned into a plurality of sub-graphs, and each sub-graph can be fed into the trained graph neural network 102 to generate a prediction on whether the given sub-graph contains a defect(s). The partitioned sub-graphs represent neighborhoods within the fabricated part and can be used to provide information regarding which melt pool measurement locations influence which defect locations (in three dimensions). These neighborhoods can include melt pool data from several layers above a given defect location. In the context of metal AM processes, such information allows a graph neural network to learn correlations and dependencies among melt pools that spatially-vary along the laser's optical path during the AM process. In the depicted example of FIG. 1, the graph generator module 114 includes a graph partitioning module 116 for partitioning the graph into the plurality of sub-graphs. The graph can be partitioned based on various criteria. In some implementations, the graph is partitioned based on a predetermined geometric shape. For example, the graph can be partitioned into a plurality of conical sub-graphs. Any geometric shape can be utilized, including but not limited to pyramids, cylinders, prisms, etc.

The graph, or sub-graphs, can be fed into the trained graph neural network 102 to generate a predicted defect output 118 describing defect information that can include the presence and/or location of predicted defect(s) in the additively-manufactured part. The predicted defect output 118 can be formatted in various ways. For example, the predicted defect output 118 can include a listing of nodes in the graph, or sub-graph, identified as defect nodes (e.g., predictions of every node as either a void node or a solid node). In some implementations, the predicted defect output 118 classifies one or more sub-graphs, labeling each as either void or solid to indicate whether the sub-graph is likely to contain a defect. In another example, the predicted defect output 118 includes a heatmap of defect likelihood for the interior of an additively-manufactured part.

A graph neural network can be trained in various ways to detect defects in an additively-manufactured part. In the depicted example of FIG. 1, a graph neural network training module 120 is implemented to train an untrained graph neural network 122 into the trained graph neural network 102. Various machine learning techniques can be utilized. In some implementations, the untrained graph neural network 122 is trained using supervised learning with labeled datasets to predict defects in additively-manufactured parts. Labeled datasets for the training of such graph neural networks can be generated in various ways. For example, raw data can be provided in a manner similar to the inference process described above, and ground truth labels can be provided using any processes for determining defects, including non-destructive and destructive processes, within the fabricated part associated with the raw data. For example, a labeled pair can be generated by pairing graph data corresponding to in situ measurements of a part (which can also be referred to as a “training part”) and data describing defects in said part. In the depicted example of FIG. 1, the raw data is provided in graph form using the graph generator module 114, and ground truth labels are provided using computed tomography imaging data 124, which describes defect information 126 of an additively-manufactured part fabricated by the additive manufacturing system 110.

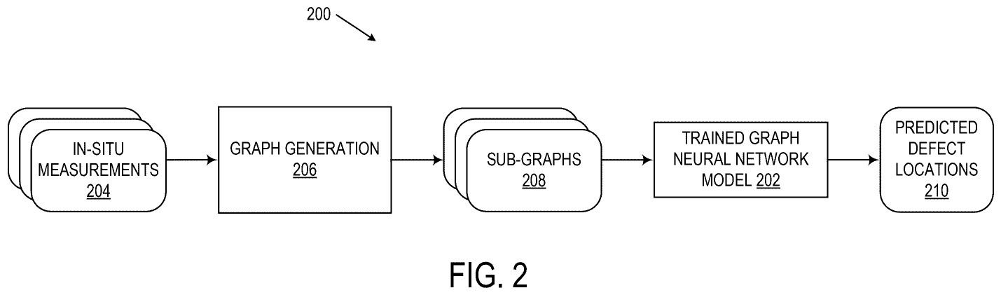

FIG. 2 shows a flow chart of an example inference process 200 for a trained graph neural network model 202. The example inference process 200 depicted can be implemented using various computing systems, including, for example, the computing system 100 depicted in FIG. 1. The data flow of the example inference process 200 starts with in situ measurements 204 of an AM process for an additively-manufactured part. The in situ measurements 204 can include melt pool data describing various characteristics of melt pools formed during the AM process. For example, melt pool characteristics can include light intensity, color temperature, spatial information, temporal information, etc.

The in situ measurements 204 are utilized in a graph generation step 206 that converts the in situ measurements 204 into graph data corresponding to the additively-manufactured part associated with the in situ measurements 204. The graph generation step 206 can be performed in various ways. In some implementations, the in situ measurements 204 include measurements for a plurality of melt pools, and construction of the graph data includes generating a node for each melt pool. The generated nodes can store data that describes characteristics of their corresponding melt pool. Various types of melt pool characteristic can be stored, including but not limited to light intensity, color temperature, spatial location, and temporal information. In some implementations, at least one of the generated nodes stores a light intensity differential value and/or a light intensity gradient value, which can be calculated using data stored in other nodes. For example, temporal information and light intensity values can be used to calculate differentials and gradients. The nodes generated for the graph can be arranged in various ways. In some implementations, the graph data includes a graph with a plurality of layers of nodes. For example, spatial information of the melt pools in the in situ measurements 204 can be used to arrange nodes within the graph. In AM processes, the fabrication is typically performed in layers. Accordingly, the nodes corresponding to melt pools of the AM process can be arranged in layers.

The graph generation step 206 further includes generating a set of edges connecting the nodes. The set of edges can be generated in various ways. In some implementations, edges connecting nodes of a given layer in the graph are generated using an algorithmic process. For example, edges connecting nodes of a layer can be generated using a Delaunay triangulation process. In further implementations, dummy nodes are added to the layer before the Delaunay triangulation process is performed to prevent unwanted edges. After performing the Delaunay triangulation process, the dummy nodes and their associated edges can be removed. The process can be repeated for each layer of nodes in the graph. Edges connecting nodes of different layers can be generated in various ways. In some implementations, edges connecting nodes of different layers are generated based on a nearest neighbor algorithm. For example, for a given node, the process can include generating a first edge to the nearest node in the layer above it and/or a second edge to the nearest node in the layer below it. In some implementations, the process is performed for every node in the graph. The edges can store various types of information. For example, an edge can store information describing the nodes that it connect, vector information of the edge, vertical distance to one or both of its adjacent layers, vector information relating to the position of the laser of the AM system, etc.

The graph generation step 206 can further include a partitioning step to partition the generated graph into a plurality of sub-graphs 208. The partitioning process can be performed in various ways. In some implementations, the graph is partitioned based on a predetermined geometric shape to form the plurality of sub-graphs 208. Various geometric shapes can be utilized, including cylinders, prisms, pyramids, etc. Depending on the configuration, different geometric shapes can provide different advantages. In some implementations, the graph is partitioned into cylindrical volumes. In other implementations, the graph is partitioned into conical volumes. Certain geometric shapes provide information that can be learned by the trained graph neural network model 202 to associate and correlate different characteristics of melt pools in vicinity of one another. For example, for a given melt pool, characteristics of melt pools between the given melt pool and the fabricating laser in line with the optical path of the laser can provide information influencing the likelihood of the given melt pool containing a defect.

The sub-graphs 208 are each fed into the trained graph neural network model 202, which can classify each node within the sub-graphs to indicate likelihoods of defects. The aggregated information from the sub-graphs 208 provides predicted defect locations 210 for the additively-manufactured part. In some implementations, the sub-graphs 208 are each classified (e.g., each sub-graph can be classified as either void or solid to indicate likelihood of the sub-graph containing a defect). The predicted defect locations 210 can be provided in various formats. In some implementations, the predicted defect locations 210 are provided as a list of nodes or sub-graphs that were classified as a node or sub-graph with a high likelihood of containing a defect. For example, the trained graph neural network model 202 can be configured to classify nodes or sub-graphs as either solid (indicating a likelihood of not having a defect) or void (indicating a likelihood of having a defect). In some implementations, the predicted defect locations 210 are provided in the form of a heatmap of defect likelihood for the additively-manufactured part.

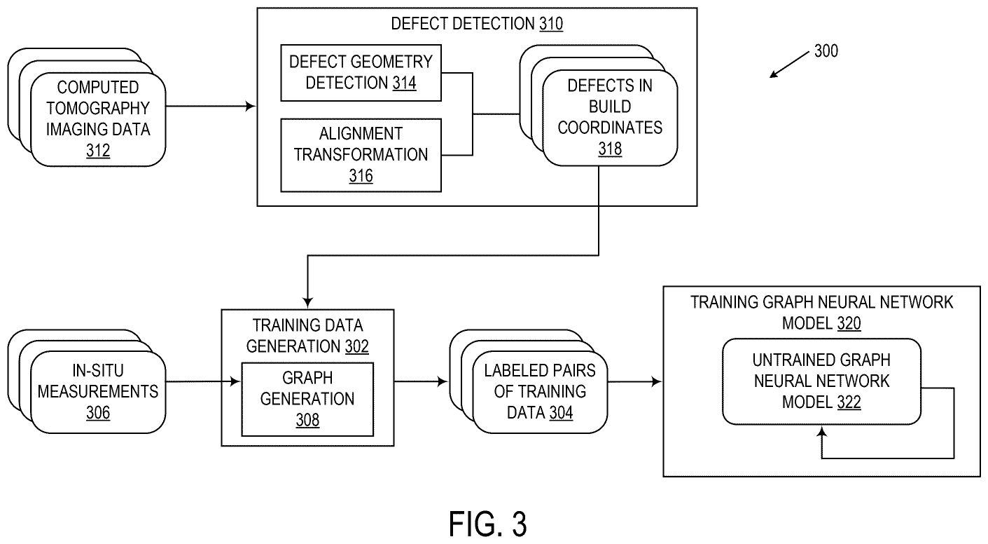

FIG. 3 shows a flow chart of an example training process 300 for a graph neural network. The example training process 300 depicted can be implemented using various computing systems, including, for example, the computing system 100 depicted in FIG. 1. The example training process 300 includes a training data generation step 302 that generates labeled pairs of training data 304. The training data generation step 302 can be performed in various ways. In some implementations, a labeled pair of training data 304 includes raw data in the form of a graph, or a plurality of sub-graphs, generated from in situ measurements 306 of an AM process for a given additively-manufactured part. Ground truth data describing defect locations for the given additively-manufactured part can be paired with the raw data to form the labeled pair of training data 304.

The graph, or plurality of sub-graphs, in a labeled pair of training data 304 can be generated using a graph generation step 308, which can be, for example, implemented similarly as the graph generation step 206 depicted in the example inference process 200 of FIG. 2. Ground truth data describing defect locations can be provided in various ways. In the depicted example, a defect detection step 310 is implemented to determine defects in the additively-manufactured part using computed tomography imaging data 312 of the additively-manufactured part. Any other method of determining defects in the additively-manufactured part can be utilized, including both destructive and non-destructive methods. In some implementations, the graph generation step 308 partitions a graph into a plurality of sub-graphs based on the detected defects. For example, the graph can include a sub-graph for each detected defect. The sub-graphs can be partitioned such that each sub-graph includes a defect and its neighboring nodes. In some implementations, a sub-graph is partitioned based on a predetermined geometric shape centering around a defect.

In the depicted example of FIG. 3, the defect detection step 310 includes using computed tomography imaging data 312 to perform defect geometry detection 314 and alignment transformation 316 to determined defect information described in the form of build coordinates 318 associated with the AM process. Defect geometry detection 314 can be performed in various ways. In some implementations, the defect geometry detection 314 includes clustering and labeling areas in the computed tomography imaging data 312 determined to be defects based on anomalous data. The alignment transformation 316 can be performed to convert the clustered areas into build coordinates 318 corresponding to the AM process of the additively-manufactured part associated with the computed tomography imaging data 312.

The example training process 300 further includes utilizing the labeled pairs of training data 304 for the training 320 of an untrained graph neural network model 322. Various machine learning techniques can be utilized for the training process 320. In the depicted example, the untrained graph neural network 322 is trained using supervised learning with the labeled pairs of training data 304 to predict defects in additively-manufactured parts.

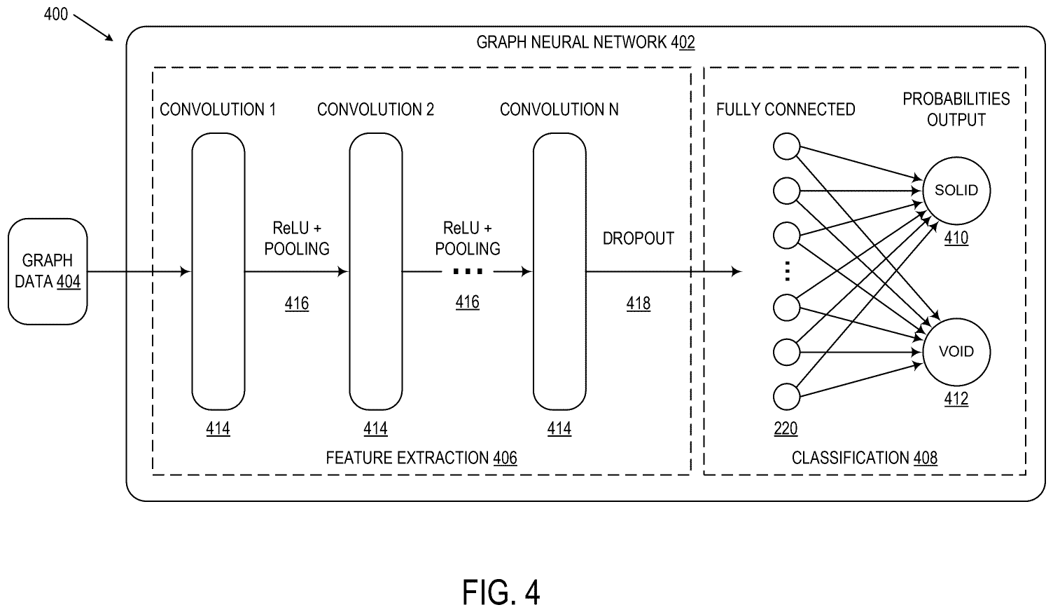

FIG. 4 shows a schematic view of an example graph neural network architecture 400. A graph neural network 402 can be implemented to operate on graph data 404. The graph neural network 402 can include, for example, the trained graph neural network 102 depicted in FIG. 1. Graph data 404 can include one or more graphs, each defined with at least a set of nodes and a set of edges. The graph neural network 402 includes a feature extraction network 406 for extracting features from the input graph data 404 and a classification network 408 for using the extracted features to classify nodes within the graph data 404 as either a solid node 410 or a void node 412 (with void nodes indicating likelihood of defects).

The feature extraction network 406 includes N convolution layers 414 for detecting features from the graph data 404. Any number N of convolution layers 414 may be implemented. The feature extraction network 406 further includes rectified liner unit and pooling layers 416 for downsampling. In the depicted example of FIG. 4, a dropout layer 418 is employed, and the remaining nodes provide a fully connected layer 420 that classifies each node as a solid node 410 and a void node 412 based on their corresponding probabilities.

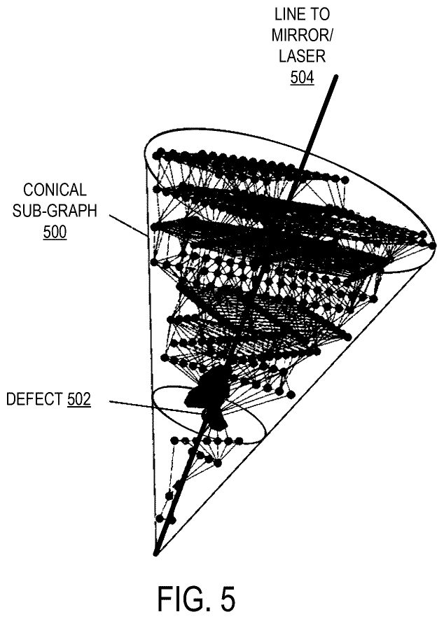

Graph neural networks can be configured to operate on graph data of various formats. For example, the graph data can include a graph that represents the entirety of an additively-manufactured part. In some implementations, the graph data includes at least one sub-graph that represents a portion of an additively-manufactured part. The sub-graph can be of a predetermined geometric shape partitioned from a graph that represents the entire additively-manufactured part. Various geometric shapes can be utilized. FIG. 5 shows a model of an example conical sub-graph 500 containing a detected defect 502. As described above with respect to FIG. 3, the graph generation step 308 can include partitioning a graph based on locations of actual defects detected in the defect detection step 310. In the example of FIG. 5, the conical sub-graph 500 represents a conical volume of an additively-manufactured part based on the location of a detected defect 502.

Sub-graphs of various geometric shapes can be implemented, including but not limited to right circular cones, oblique circular cones, truncated cones, cylinders, prisms, pyramids, etc. Different geometric shapes can provide different insights that a graph neural network can learn. Furthermore, the sub-graphs can be partitioned into volumes with predefined orientations. For example, the conical sub-graph 500 of FIG. 5 is partitioned based on an optical path of the laser utilized in the AM process. More specifically, the example conical sub-graph 500 is configured such that the line from its apex to the center of its base is in line, or substantially in line, with a path 504 from the defect location to the laser (or mirror redirecting the laser) utilized in the AM process. Use of a conical sub-graph oriented in the configuration described above provides several technical advantages. Intuitively, characteristics of melt pools between a defect and the laser/mirror in a similar optical path can have certain correlations. For example, certain dependencies and correlations found in melt pool characteristics of the intermediate melt pools can serve as an indicator of a defect somewhere in the optical path.

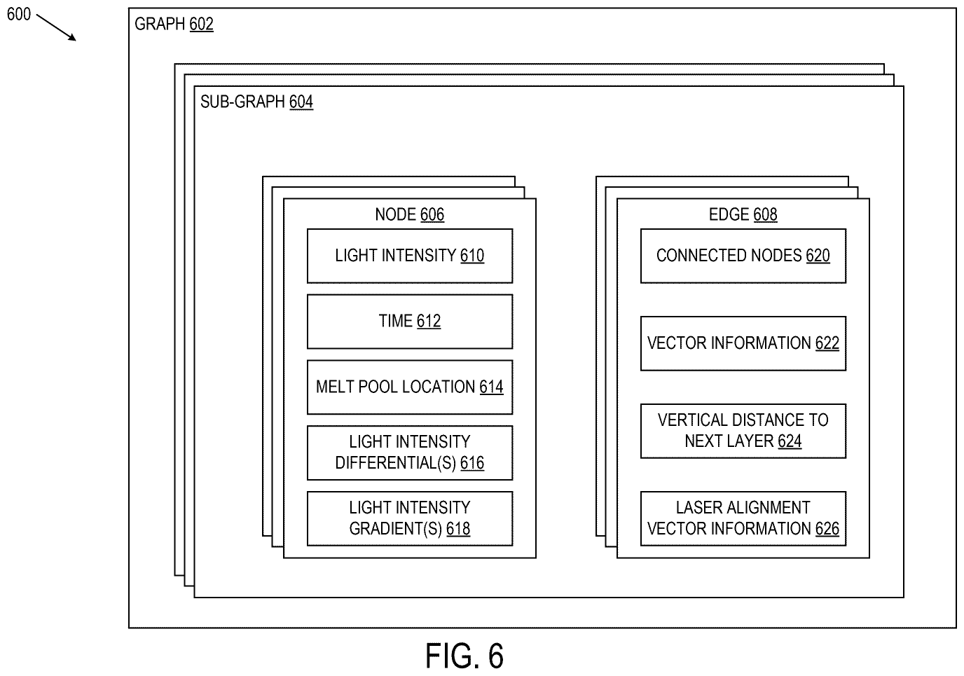

FIG. 6 shows a schematic view of an example data structure 600 of a graph 602 constructed using in situ melt pool measurements of an additive manufacturing process. The example data structure 600 illustrates hierarchical information stored in graph 602. Graph 602 can be partitioned into a plurality of sub-graphs 604, each defined with a set of nodes 606 and a set of edges 608. Information, such as melt pool characteristics, can be stored in the nodes 606 and/or edges 608 and used by a graph neural network to learn various correlations and dependencies among the characteristics of different melt pools to identify likelihoods of defects. In the depicted example, each of the nodes 606 stores melt pool characteristics including one or more of the following: light intensity 610, temporal information 612, location of the melt pool 614, light intensity differential 616, and light intensity gradient 618. Each edge 608 stores one or more of the following: node information 620 describing the nodes 606 that they connect, vector information 622 describing the edges, vertical distance to the next layer 624, and laser alignment vector information 626.

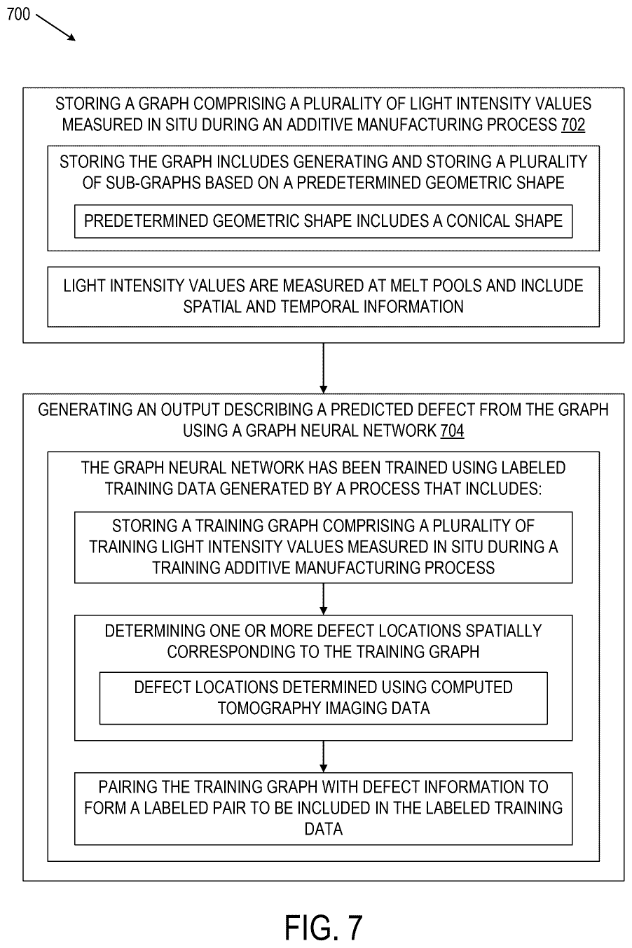

FIG. 7 shows a flow chart of an example method 700 for performing defect detection of an additively-manufactured part. The method 700 includes, at step 702, storing a graph that includes a plurality of light intensity values. Storing the graph can be performed in various ways. In some implementations, storing the graph includes receiving in situ measurements of an additive manufacturing process of the additively-manufactured part/article and constructing the graph using the received in situ measurements. The received in situ measurements can include a plurality of light intensity values for a plurality of melt pools formed during the additive manufacturing process. In some implementations, the in situ measurements include spatial and/or temporal information describing locations of the melt pools and/or the times at which the in situ measurements of the melt pools were taken.

Constructing the graph can be performed in various ways. The graph can be constructed by generating a plurality of nodes corresponding to the melt pools of the additive manufacturing process and by generating a plurality of edges interconnecting the plurality of nodes. In some implementations, the plurality of nodes is arranged in layers. The plurality of edges connecting the nodes can be generated in various ways. For example, edges connecting nodes within a layer can be generated using a Delaunay triangulation process. In some implementations, dummy nodes are added before performing the Delaunay triangulation process. Afterwards, the dummy nodes and their associated edges can be removed. The process can be repeated for each layer of nodes. Edges connecting nodes of different layers can be generated based on a nearest neighbor algorithm. For example, for each node, an edge can be generated to connect the node and the nearest node in the adjacent layer above/below it.

Various information can be stored in the nodes and/or edges. In some implementations, each node stores a spatially corresponding light intensity value from the plurality of light intensity values. Other melt pool characteristics can also be stored. For example, each node can store melt pool characteristics including one or more of the following: light intensity, temporal information, location of the melt pool, light intensity differential, and light intensity gradient. In some implementations, each edge stores one or more of the following: information describing the nodes that they connect, vector information describing the edges, vertical distance to the next layer, and laser alignment vector information.

In some implementations, storing the graph includes generating and storing a plurality of sub-graphs. The sub-graphs can be partitioned from the constructed graph based on at least one predetermined criterion. For example, the sub-graphs can be partitioned based on a predetermined geometric shape. In some implementations, the predetermined geometric shape includes a conical shape. Various geometric shapes can be utilized, including but not limited to cones, pyramids, prisms, etc. The sub-graphs can be partitioned with certain orientations. In some implementations, at least one of the sub-graphs is partitioned to be oriented based on a location of a laser used in the additive manufacturing process.

The method 700 includes, at step 704, generating an output describing a predicted defect from the graph using a graph neural network. The predicted defect can be a predicted defect node or a predicted defect sub-graph. The predicted defect output can be formatted in various ways. In some implementations, the predicted defect output includes a listing of nodes, or sub-graphs, identified as defect nodes, or defect sub-graphs. For example, the graph neural network can be configured to classify each sub-graph in the graph as either a sub-graph with a defect within it or a sub-graph without a defect, and the predicted defect output can include a listing of void sub-graphs. In other implementations, each node within the graph, or sub-graphs, is individually classified as either a solid node or a void node, and the predicted defect output includes a listing of void nodes. In some implementations, the predicted defect output includes a heatmap of defect likelihood for the interior of the additively-manufactured part.

Various types of graph neural networks can be utilized including those depicted and described in FIGS. 1-4. In some implementations, the graph neural network has been trained using labeled training data. The labeled training data can be generated in various ways. In some implementations, the labeled training data is generated by storing a training graph that includes a plurality of training light intensity values. The training light intensity values can be measured in situ during a training additive manufacturing process for fabricating a training part/article. One or more defects of the training part/article and its corresponding location on the training graph can be determined. In some implementations, a plurality of training sub-graphs is partitioned from the training graph based on at least one predetermined criterion. For example, the partitioning process can be based on a predetermined geometric shape. In some implementations, a training sub-graph is partitioned from the training graph based on determined defect locations. Defects can be determined in various ways, including but not limited to the use of computed tomography imaging data. The training graph, or plurality of training sub-graphs, can be paired with the defect information to form a labeled pair to be included in the labeled training data.

The use of graph neural networks instead of raster-based convolution neural networks to perform defect detection in AM processes provides several technical advantages. Instead of point-estimate node embedding, graph neural networks enable the use of network embedding to find defects. In some implementations, three-dimensional real-time in-situ modeling of a fabricated part, or a part being fabricated, can be performed. Such implementations enable a multi-layer holistic approach to predicting defect probability compared to current techniques that do not require multi-layer data to align to a voxel three-dimensional grid.

In some implementations, the example method 700 is performed before the additive manufacturing process finishes fabricating the additively-manufactured article. For example, during the additive manufacturing process, defect detection using the example method 700 can be performed in situ to determine likelihood of defects that have been formed. Upon determining that too many defects or defects that are too large have been formed, the additive manufacturing process can be halted, saving time and cost that would have been wasted in finishing fabrication of the additive-manufactured part.

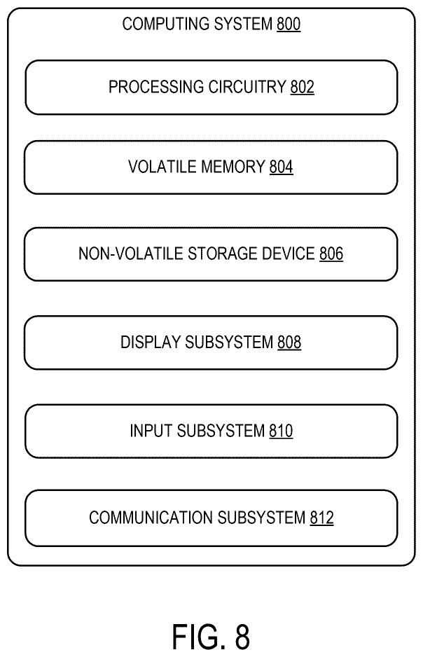

FIG. 8 schematically shows a non-limiting embodiment of a computing system 800 that can enact one or more of the methods and processes described above. Computing system 800 is shown in simplified form. Computing system 800 may embody the computing system 100 described above and illustrated in FIG. 1, respectively. Components of computing system 800 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 800 includes processing circuitry 802, volatile memory 804, and a non-volatile storage device 806. Computing system 800 may optionally include a display subsystem 808, input subsystem 810, communication subsystem 812, and/or other components not shown in FIG. 8.

Processing circuitry typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the processing circuitry 802 may be single-core or multi-core, and the instructions executed thereon may be configured for sequential, parallel, and/or distributed processing. Individual components of the processing circuitry optionally may be distributed among two or more separate devices, which may be remotely located and/or configured for coordinated processing. For example, aspects of the computing system disclosed herein may be virtualized and executed by remotely accessible, networked computing devices configured in a cloud-computing configuration. In such a case, these virtualized aspects are run on different physical logic processors of various different machines, it will be understood. These different physical logic processors of the different machines will be understood to be collectively encompassed by processing circuitry 802.

Non-volatile storage device 806 includes one or more physical devices configured to hold instructions executable by the processing circuitry to implement the methods and processes described herein. When such methods and processes are implemented, the state of non-volatile storage device 806 may be transformed—e.g., to hold different data.

Non-volatile storage device 806 may include physical devices that are removable and/or built in. Non-volatile storage device 806 may include optical memory, semiconductor memory, and/or magnetic memory, or other mass storage device technology. Non-volatile storage device 806 may include nonvolatile, dynamic, static, read/write, read-only, sequential-access, location-addressable, file-addressable, and/or content-addressable devices. It will be appreciated that non-volatile storage device 806 is configured to hold instructions even when power is cut to the non-volatile storage device 806.

Volatile memory 804 may include physical devices that include random access memory. Volatile memory 804 is typically utilized by processing circuitry 802 to temporarily store information during processing of software instructions. It will be appreciated that volatile memory 804 typically does not continue to store instructions when power is cut to the volatile memory 804.

Aspects of processing circuitry 802, volatile memory 804, and non-volatile storage device 806 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 800 typically implemented in software by a processor to perform a particular function using portions of volatile memory, which function involves transformative processing that specially configures the processor to perform the function. Thus, a module, program, or engine may be instantiated via processing circuitry 802 executing instructions held by non-volatile storage device 806, using portions of volatile memory 804. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 808 may be used to present a visual representation of data held by non-volatile storage device 806. The visual representation may take the form of a GUI. As the herein described methods and processes change the data held by the non-volatile storage device, and thus transform the state of the non-volatile storage device, the state of display subsystem 808 may likewise be transformed to visually represent changes in the underlying data. Display subsystem 808 may include one or more display devices utilizing virtually any type of technology. Such display devices may be combined with processing circuitry 802, volatile memory 804, and/or non-volatile storage device 806 in a shared enclosure, or such display devices may be peripheral display devices.

When included, input subsystem 810 may comprise or interface with one or more user-input devices such as a keyboard, mouse, touch screen, camera, or microphone.

When included, communication subsystem 812 may be configured to communicatively couple various computing devices described herein with each other, and with other devices. Communication subsystem 812 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 800 to send and/or receive messages to and/or from other devices via a network such as the Internet.

Further, the disclosure comprises configurations according to the following clauses.
Clause 1. A computing device for detecting defects in an additively-manufactured article, the computing device comprising: processing circuitry and memory storing instructions that, when executed by the processing circuitry, causes the processing circuitry to: store a graph comprising a plurality of light intensity values measured in situ during an additive manufacturing process of the additively-manufactured article; and generate an output describing a predicted defect in the graph using a graph neural network, wherein the graph neural network has been trained using labeled training data generated by a process comprising: storing a training graph comprising a plurality of training light intensity values measured in situ during a training additive manufacturing process of a training article; determining one or more defect locations of the training article; determining a plurality of training sub-graphs from the training graph; and pairing a training sub-graph of the plurality of training sub-graphs with defect information to form a labeled pair to be included in the labeled training data, wherein the defect information describes whether a defect is spatially present in the paired training sub-graph based on the determined one or more defect locations.
Clause 2. The computing device of clause 1, wherein the one or more defect locations are determined using computed tomography imaging data.
Clause 3. The computing device of clause 1 or clause 2, wherein storing the graph comprises: receiving the plurality of light intensity values and associated spatial information; and constructing the graph by: generating a plurality of nodes, each node storing a spatially corresponding light intensity value of the plurality of light intensity values; and generating a plurality of edges interconnecting the plurality of nodes.
Clause 4. The computing device of clause 3, wherein the plurality of nodes comprises layers of nodes, wherein the plurality of edges is partially generated using a Delaunay triangulation process for each of the layers of nodes.
Clause 5. The computing device of clause 4, wherein edges connecting nodes of different layers are generated based on a nearest neighbor algorithm.
Clause 6. The computing device of clauses 3 to 5, wherein each of the plurality of nodes stores a light intensity differential value and a light intensity gradient value.
Clause 7. The computing device of clauses 3 to 6, wherein each of the plurality of edges stores a value describing a relative alignment to a laser device used in the additive manufacturing process.
Clause 8. The computing device of clauses 1 to 7, wherein the instructions, when executed by the processing circuitry, further causes the processing circuitry to partition the stored graph into a plurality of sub-graphs based on a predetermined geometric shape, wherein the output describing the predicted defect is generated using the graph neural network and a sub-graph of the plurality of sub-graphs, and wherein the predicted defect is a predicted defect sub-graph.
Clause 9. The computing device of clause 8, wherein the predetermined geometric shape is conical.
Clause 10. The computing device of clauses 1 to 9, wherein at least one of the training sub-graphs is oriented based on a location of a laser used in the additive manufacturing process.
Clause 11. The computing device of clauses 1 to 10, wherein determining the plurality of training sub-graphs comprises, for each of the determined one or more defect locations, determining a training sub-graph that includes the defect location.
Clause 12. A method for detecting defects in an additively-manufactured article, the method comprising: storing a graph comprising a plurality of light intensity values measured in situ during an additive manufacturing process of the additively-manufactured article; and generating an output describing a predicted defect in the graph using a graph neural network, wherein the graph neural network has been trained using labeled training data generated by a process comprising: storing a training graph comprising a plurality of training light intensity values measured in situ during a training additive manufacturing process of a training article; determining one or more defect locations of the training article spatially corresponding to the training graph; and pairing the training graph with defect information to form a labeled pair to be included in the labeled training data, wherein the defect information describes whether a defect is spatially present in the training graph based on the determined one or more defect locations.
Clause 13. The method of clause 12, wherein the one or more defect locations are determined using computed tomography imaging data.
Clause 14. The method of clause 12 or clause 13, wherein storing the graph comprises: receiving the plurality of light intensity values and associated spatial information; and constructing the graph by: generating a plurality of nodes, each node storing a spatially corresponding light intensity value of the plurality of light intensity values; and generating a plurality of edges interconnecting the plurality of nodes.
Clause 15. The method of clause 14, wherein the plurality of nodes comprises layers of nodes, wherein the plurality of edges is partially generated using a Delaunay triangulation process for each of the layers of nodes, and wherein edges connecting nodes of different layers are generated based on a nearest neighbor algorithm.
Clause 16. The method of clause 14 or clause 15, wherein each of the plurality of nodes stores a light intensity differential value and a light intensity gradient value.
Clause 17. The method of clauses 14 to 16, wherein each of the plurality of edges stores a value describing a relative alignment to a laser device used in the additive manufacturing process.
Clause 18. The method of clauses 12 to 17, further comprising partitioning the stored graph into a plurality of sub-graphs based on a predetermined geometric shape, wherein the output describing the predicted defect is generated using the graph neural network and a sub-graph of the plurality of sub-graphs, and wherein the predicted defect is a predicted defect sub-graph.
Clause 19. The method of clauses 12 to 18, wherein the method is performed before the additive manufacturing process finishes fabricating the additively-manufactured article.
Clause 20. A method for training a graph neural network, the method comprising: storing computed tomography imaging data of a training article and a plurality of training light intensity values measured in situ during a training additive manufacturing process of the training article; generating a training graph using the plurality of training light intensity values; determining one or more defect locations of the training article using the computed tomography imaging data; determining a plurality of training sub-graphs from the training graph, wherein a subset of the plurality of training sub-graphs is determined such that each of the training sub-graphs in the subset includes a defect location of the one or more defect locations; pairing each of the training sub-graphs with defect information describing whether a defect is present to generate labeled training data; and training a graph neural network with the labeled training data.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing device for detecting defects in an additively-manufactured article, the computing device comprising:
processing circuitry and memory storing instructions that, when executed by the processing circuitry, causes the processing circuitry to:
store a graph comprising a plurality of light intensity values measured in situ during an additive manufacturing process of the additively-manufactured article; and
generate an output describing a predicted defect in the graph using a graph neural network, wherein the graph neural network has been trained using labeled training data generated by a process comprising:
storing a training graph comprising a plurality of training light intensity values measured in situ during a training additive manufacturing process of a training article;
determining one or more defect locations of the training article;
determining a plurality of training sub-graphs from the training graph; and
pairing a training sub-graph of the plurality of training sub-graphs with defect information to form a labeled pair to be included in the labeled training data, wherein the defect information describes whether a defect is spatially present in the paired training sub-graph based on the determined one or more defect locations.

2. The computing device of claim 1, wherein the one or more defect locations are determined using computed tomography imaging data.

3. The computing device of claim 1, wherein storing the graph comprises:
receiving the plurality of light intensity values and associated spatial information; and
constructing the graph by:
generating a plurality of nodes, each node storing a spatially corresponding light intensity value of the plurality of light intensity values; and
generating a plurality of edges interconnecting the plurality of nodes.

4. The computing device of claim 3, wherein the plurality of nodes comprises layers of nodes, wherein the plurality of edges is partially generated using a Delaunay triangulation process for each of the layers of nodes.

5. The computing device of claim 4, wherein edges connecting nodes of different layers are generated based on a nearest neighbor algorithm.

6. The computing device of claim 3, wherein each of the plurality of nodes stores a light intensity differential value and a light intensity gradient value.

7. The computing device of claim 3, wherein each of the plurality of edges stores a value describing a relative alignment to a laser device used in the additive manufacturing process.

8. The computing device of claim 1, wherein the instructions, when executed by the processing circuitry, further causes the processing circuitry to:
partition the stored graph into a plurality of sub-graphs based on a predetermined geometric shape, wherein the output describing the predicted defect is generated using the graph neural network and a sub-graph of the plurality of sub-graphs, and wherein the predicted defect is a predicted defect sub-graph.

9. The computing device of claim 8, wherein the predetermined geometric shape is conical.

10. The computing device of claim 1, wherein at least one of the training sub-graphs is oriented based on a location of a laser used in the additive manufacturing process.

11. The computing device of claim 1, wherein determining the plurality of training sub-graphs comprises:
for each of the determined one or more defect locations, determining a training sub-graph that includes the defect location.

12. A method for detecting defects in an additively-manufactured article, the method comprising:
storing a graph comprising a plurality of light intensity values measured in situ during an additive manufacturing process of the additively-manufactured article; and
generating an output describing a predicted defect in the graph using a graph neural network, wherein the graph neural network has been trained using labeled training data generated by a process comprising:
storing a training graph comprising a plurality of training light intensity values measured in situ during a training additive manufacturing process of a training article;
determining one or more defect locations of the training article spatially corresponding to the training graph; and
pairing the training graph with defect information to form a labeled pair to be included in the labeled training data, wherein the defect information describes whether a defect is spatially present in the training graph based on the determined one or more defect locations.

13. The method of claim 12, wherein the one or more defect locations are determined using computed tomography imaging data.

14. The method of claim 12, wherein storing the graph comprises:
receiving the plurality of light intensity values and associated spatial information; and
constructing the graph by:
generating a plurality of nodes, each node storing a spatially corresponding light intensity value of the plurality of light intensity values; and
generating a plurality of edges interconnecting the plurality of nodes.

15. The method of claim 14, wherein the plurality of nodes comprises layers of nodes, wherein the plurality of edges is partially generated using a Delaunay triangulation process for each of the layers of nodes, and wherein edges connecting nodes of different layers are generated based on a nearest neighbor algorithm.

16. The method of claim 14, wherein each of the plurality of nodes stores a light intensity differential value and a light intensity gradient value.

17. The method of claim 14, wherein each of the plurality of edges stores a value describing a relative alignment to a laser device used in the additive manufacturing process.

18. The method of claim 12, further comprising:
partitioning the stored graph into a plurality of sub-graphs based on a predetermined geometric shape, wherein the output describing the predicted defect is generated using the graph neural network and a sub-graph of the plurality of sub-graphs, and wherein the predicted defect is a predicted defect sub-graph.

19. The method of claim 12, wherein the method is performed before the additive manufacturing process finishes fabricating the additively-manufactured article.

20. A method for training a graph neural network, the method comprising:
storing computed tomography imaging data of a training article and a plurality of training light intensity values measured in situ during a training additive manufacturing process of the training article;
generating a training graph using the plurality of training light intensity values;
determining one or more defect locations of the training article using the computed tomography imaging data;
determining a plurality of training sub-graphs from the training graph, wherein a subset of the plurality of training sub-graphs is determined such that each of the training sub-graphs in the subset includes a defect location of the one or more defect locations;
pairing each of the training sub-graphs with defect information describing whether a defect is present to generate labeled training data; and
training a graph neural network with the labeled training data.
